(19) United States
(12) Patent Application Publication
(10) Pub. No.: US 2009/0055589 A1
(43) Pub. Date: Feb. 26, 2009

(54) Cache memory system for a data processing apparatus

(75) Inventors: Daren Croxford, Cambridge (GB); Timothy Fawcett Milner, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/892,667

(22) Filed: Aug. 24, 2007

(51) Int. Cl. G06F 12/00

(52) U.S. Cl. 711/119; 711/E12.002

(57) ABSTRACT

A data processing apparatus is provided having a cache memory 262, 264, a cache controller 240 and a location-specifying memory 252. The location-specifying memory is configured to store mapping data providing a mapping between a given memory address and a storage location in the cache. The stored mapping data is used instead of performing a cache look up to access the information corresponding to the given memory address in the cache memory. Furthermore, a data processing apparatus is provided having a pipelined processing circuit 220, a cache memory 262, 264, loop detection circuitry, branch prediction circuitry 232 and control circuitry 240. The branch prediction circuitry is configured to generate branch prediction information, which is used by the control circuitry to control which program instructions of detected program loops are stored by the buffer memory.

### BACKGROUND OF THE INVENTION

1. Field of the Invention

This invention relates to the field of data processing systems. More particularly, this invention relates to cache memory techniques in data processing systems.

2. Description of the Prior Art

It is known to use cache memory to increase the efficiency with which data is retrieved from a main memory of a data processing system. More frequently accessed data and/or instructions are stored in cache, which, due to its size and physical characteristics is more rapidly accessible than main memory. Cache tags are used to locate information corresponding to a given memory address in cache. Known data processing systems have one or more levels of cache, which can be arranged hierarchically such that caches at successive levels of the hierarchy are sequentially accessed.

However, caches can account for a significant proportion of the power consumption of a data processing apparatus. For example, a level one (L1) cache may account for about fifty percent of a processor's power and the cache tag look up of such an L1 cache could account for around forty percent of the power consumption of the cache itself. For set-associative caches, which comprise a plurality of cache arrays, as the number of cache arrays increases, the cache tag look-up power consumption increases. In fact, the cache tag look-up for an L1 cache can account for around twenty percent of a processor's total power consumption.

There are a number of known schemes to ameliorate the effects of the large power consumption of caches in data processing systems. One such known system is to use, in addition to a standard cache, a loop cache to store loops of program instructions. The loop cache is typically located in an alternative access pathway to the L1 cache. Loop caches can be used to reduce the power consumption of instruction caches but not data caches.

Loop caches can reduce L1 instruction cache power consumption by around forty percent so that overall the processor power consumption is reduced by around twenty percent.

Other known systems comprise filter caches, which can be used to reduce cache power consumption for both data caches and instruction caches. Filter caches are typically implemented as small level zero (L0) caches between the processor and the L1 cache. The fact that the filter cache is used at L0 of the cache hierarchy means that they can adversely impact the processor's performance due to high filter cache miss rates.

However, filter caches can still reduce overall processor power consumption.

In order to make data processing systems more efficient it is desirable to further reduce the power consumption of cache memory systems.

### SUMMARY OF THE INVENTION

According to a first aspect the present invention provides apparatus for processing data comprising:

a cache memory having a data storage array comprising a plurality of cache lines and a cache tag array providing an index of memory locations associated with data elements currently stored in said cache memory;

a cache controller coupled to said cache memory and responsive to a cache access to perform a cache lookup with reference to said cache tag array to establish whether a data element corresponding to a given memory address is currently stored in said cache memory and, if so, to identify a mapping between said given memory address and a corresponding cache storage location;

a location-specifying memory operable to store at least a portion of said mapping determined during said cache lookup;

wherein upon a subsequent cache access to said given memory address said cache controller is arranged to access said location-specifying memory and to use said stored mapping to access said data element corresponding to said given memory address in said data storage array of said cache memory instead of performing said cache lookup.

The present invention according to this first aspect recognises that provision of a location-specifying memory to store at least a portion of a mapping determined during a cache look up can reduce the instruction cache power consumption by improving the efficiency with which data is accessed. The stored mapping data can be used to perform subsequent accesses, which avoids the requirement to perform a power-hungry cache look up involving a plurality of cache tag Random Access Memories (RAMs). Furthermore, storing the mapping data or a portion thereof means that the corresponding instruction or data itself need not be stored in the loop cache or filter cache but instead can be readily accessed in, for example, an L1 cache using the stored mapping data. In this way, the gate-count and power consumption of the cache memory system can be reduced. The location-specifying memory can thus be reduced in complexity and will be simpler to manufacture than a loop or filter cache that is required to store the full cached data or instruction.

It will be appreciated that the location-specifying memory could be an integral part of the cache memory. However, in one embodiment, the data processing apparatus comprises a further cache memory and the further cache memory comprises the location-specifying memory.

Although the further cache memory could store at least a portion of the cache line data corresponding to the stored mapping data, in one embodiment the further cache memory stores the mapping data without storing corresponding cache line data and the data processing apparatus is configured to use the mapping data from the further cache memory to retrieve the information from the cache memory. This allows the storage capacity of the further cache to be more efficiently used by reducing the number of power-hungry cache tag look-ups yet obviating the need to replicate full cache lines.

Although the cache memory system can be configured such that the cache memory and the further cache memory are provided on alternative access paths on the same hierarchical level, in one embodiment the cache memory and the further cache memory form a cache hierarchy having a plurality of hierarchical levels and the further cache memory belongs to a lower hierarchical level than the cache memory. In one such embodiment the further cache memory is a filter cache and the cache memory is a level-one cache.

In one embodiment the further cache memory is a buffer memory. This is straightforward to implement.

In some embodiments of the invention the cache memory is an instruction cache and in other embodiments the cache memory is a data cache. In yet other embodiments the cache memory caches both instructions and data.

It will be appreciated that the further cache memory could comprise any type of cache memory. However, in one embodiment, the data processing apparatus comprises loop detection circuitry and the further cache memory is a loop cache.

The cache memory could be any type of cache memory such as a directly-mapped cache, but in one embodiment the cache memory is a set-associative cache memory having a plurality of cache ways.

In one such embodiment having a set-associative cache, the mapping comprises at least one of an index specifying a set of cache lines and cache way information corresponding to the given memory address. This information can be stored compactly yet enables the corresponding information to be readily and efficiently retrieved from the cache without the need to perform a cache-tag look up.

In one embodiment the data processing apparatus comprises invalidation circuitry coupled to the cache memory and the location-specifying memory, wherein the invalidation circuitry is arranged to selectively invalidate mapping data stored in the location-specifying memory when a corresponding line of the cache memory is invalidated.

In an alternative embodiment the invalidation circuitry is configured to flush all of the mapping information from the location-specifying memory when at least one line of the cache memory is invalidated.

It will be appreciated that the mapping information could be stored in the location-specifying memory following any cache tag look-up. However, in one embodiment the data processing apparatus comprises a main memory and the mapping information is stored in the location-specifying memory in response to the information being retrieved from the main memory and stored in the cache. This further reduces the required number of cache tag look ups relative to only storing the mapping data in response to a cache hit.

According to a second aspect, the present invention provides an apparatus for processing data comprising:

a pipelined processing circuit for executing program instructions including conditional branch instructions;

a cache memory;

loop detection circuitry responsive to memory addresses of instructions to detect program loops;

a buffer memory coupled to the cache memory and the loop detection circuitry, the buffer memory being arranged to store instruction data for at least a portion of one of the detected program loops;

branch prediction circuitry configured to generate branch prediction information providing a prediction of whether a given one of the conditional branch instructions will result in a change in program execution flow;

control circuitry coupled to the buffer memory and the branch prediction circuitry, the control circuitry arranged to control the buffer memory to store program instructions in dependence upon the branch prediction information.

The present invention according to this second aspect recognises that the loading of instructions corresponding to detected program loops into the buffer memory consumes power and accordingly that efficiency can be improved by only selectively storing detected program loops based on offsetting the performance gains that are achievable by repeatedly accessing instructions of the program loop from the buffer memory rather than from cache memory or main memory against the power consumed in order to store instruction loops in the buffer memory. This is achieved by feeding branch prediction information from the branch prediction circuitry to the control circuitry that controls the buffer memory to store detected program loops such that only those instructions that are most likely to be part of a successively iterated loop are in fact stored in the buffer memory.

In one embodiment the buffer memory is coupled to the loop detection circuitry, the buffer memory being arranged to store at least a portion of the program loop. This provides for more efficient repeated access to program instructions of a repeatedly iterated loop of program instructions.

In one embodiment the apparatus comprises branch target prediction circuitry for predicting a branch-target instruction address corresponding to the given conditional branch instruction. In one such embodiment the branch prediction information comprises the branch-target instruction address. This provides for timely identification of candidate loop instructions for storing in the buffer memory.

In one embodiment, the loop detection circuitry performs the detection of program loops by statically profiling a sequence of program instructions. In an alternative embodiment, the loop detection circuitry performs the detection of program loops by dynamically identifying small backwards branches during execution of program instructions. This scheme reliably identifies most program loops yet is straightforward to implement.

In one embodiment the branch prediction circuitry is configured to provide a likelihood value giving a likelihood that a predicted branch will be taken and wherein the control circuitry is responsive to the likelihood value to control storage of program instructions corresponding to the predicted branch.

In one embodiment the buffer memory is configured to store mapping information providing a mapping between a memory address and a storage location of one or more program instructions corresponding to the memory address in the cache memory.

In one such embodiment the buffer memory is configured to store the mapping information without storing the corresponding program instructions and wherein the data processing apparatus is configured to use the mapping information to retrieve the program instructions from the cache memory.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a cache memory;

FIG. 2 schematically illustrates a first arrangement of a data processing apparatus corresponding to the present technique;

FIG. 3 schematically illustrates the mapping information stored by the location-specifying memory according to the present technique;

FIG. 4 schematically illustrates a second arrangement of a data processing apparatus according to the present technique;

FIG. 5 is a flow chart that schematically illustrates how an instruction access is performed in the data processing apparatus of FIG. 2, which comprises a loop cache;

FIG. 6 is a flow chart that schematically illustrates a first scheme for invalidating loop cache entries;

FIG. 7 is a flow chart that schematically illustrates a second scheme for invalidating loop cache entries;

FIG. 8 is a flow chart describing an instruction access in the data processing apparatus of FIG. 2 and where branch prediction circuitry is used to determine how the loop cache should be loaded;

FIG. 9 is a flow chart that schematically illustrates a sequence of processing events that occurs when a memory access is performed in the filter cache arrangement of FIG. 4; and

FIG. 10A and FIG. 10B schematically illustrate two alternative filter cache invalidation schemes.

### DESCRIPTION OF THE PREFERRED EMBODIMENTS

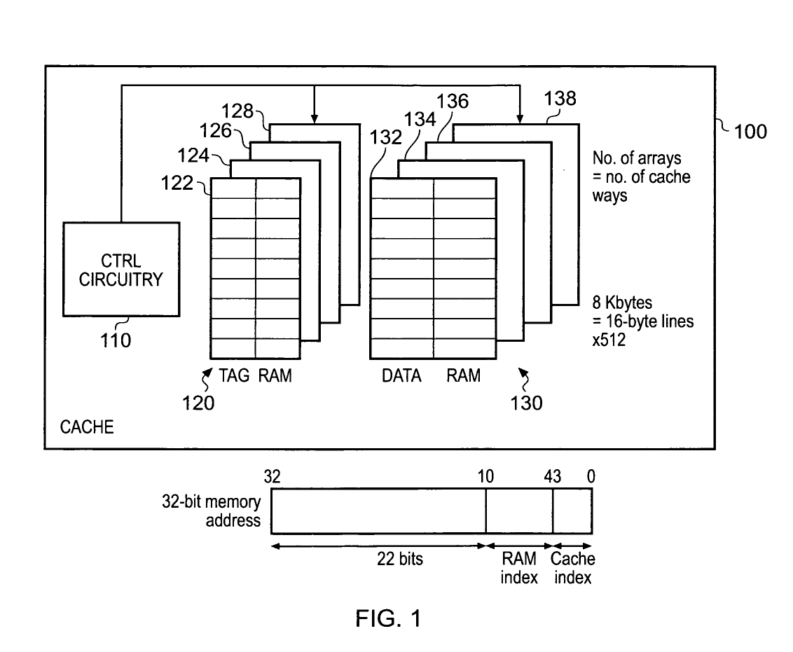

FIG. 1 schematically illustrates a cache memory. The cache memory 100 comprises: cache control circuitry 110; a cache tag RAM 120 having four tag arrays 122, 124, 126, 128; and a data RAM 130 having four data arrays 132, 134, 136, 138.

The control circuitry 110 is responsive to a request from a data processor (not shown) to perform a cache access operation (read or write) by looking up the tag RAM 120 to determine whether data corresponding to a given memory address is stored in a corresponding location in the data RAM 130.

In the cache 100 of FIG. 1, different (non-contiguous) memory addresses can be attached to each of a plurality of cache lines of the data RAM 130. In this particular example arrangement, the data RAM is an 8 kilobyte data RAM having a plurality of cache lines, each of which is 16 bytes long. In general, if a cache line is n bytes long then that cache line will hold n bytes from main memory that fall of an n-byte boundary. Thus, in the example of FIG. 1, an individual cache line holds a 16-byte block of data from main memory, whose addresses fall on 16 byte boundaries.

The tag RAM 120 comprises four individual data arrays 122, 124, 126 and 128 having a one-to-one correspondence with the four data arrays of the data RAM 130 i.e. arrays 132, 134, 136 and 138. Since the cache 100 has four data arrays it is referred to as a “four-way” set associative cache. The 8 kilobyte cache 100 comprises a total of 512 16-byte cache lines and each data array of the data RAM 130 comprises 128 cache lines. The tag RAM 120 provides a mapping between an incoming memory address, in this case a 32-bit address, and a data storage location within the data RAM 130.

A processor (not shown) selects a particular set of cache lines using a “data RAM index” comprising subset of the address bits of the 32-bit memory address. Within each data RAM array 132, 134, 136, 138 there are four cache lines that could map to a given memory address. The control circuitry 110 uses a mapping algorithm to select one of the four cache lines within the set on a cache line fill.

As shown in FIG. 1, bits 4 to 10 of the 32-bit memory address are used as the RAM index, which specifies one of the 128 different sets of cache lines (each comprising four cache lines corresponding to four cache ways). Bits 0 to 3 of the 32-bit memory address specify items within the cache line.

In FIG. 1 a single cache 100 is shown, but in alternative arrangements separate caches are used for instructions and for data. For example, an 8 kilobyte instruction cache and a separate 8 kilobyte data cache could be implemented rather than a 16 kilobyte unified cache. In the arrangement of FIG. 1 data corresponding to a given memory address can be stored in any one of four cache lines of the set of cache lines associated with that memory address. The control circuitry 110 selects which one of the four cache lines will be used to store the data. A replacement algorithm is used to determine which data to evict from the cache in the event that there is no available space in a given set of cache lines. When a data processor attempts to access the location in main memory it checks whether the data associated with the memory address in the cache by comparing the memory address to all tags in the tag RAM 120 that might contain data associated with that address.

During the look up of the tag RAM 120 of FIG. 1, all four tag RAM arrays 122, 124, 126 and 128 are looked up in parallel by the control circuitry 110. This is a power-hungry process. Indeed an L1 cache can account for around fifty percent of a processor's power consumption and the cache tag look up accounts for around 40% of the power consumption of the L1 cache itself (20% of total processor power consumption). Furthermore, the cache tag look-up power consumption increases as the number of cache ways increase.

As mentioned above, there are a number of known schemes for reducing cache power consumption. For example, a loop cache can be provided to store loops of frequently executed instructions or a filter cache can be provided as an L0 cache (between a processor and an L1 cache) to store data or instructions.

The present technique provides a way of reducing the power consumption associated with the parallel look up of the tag RAM 120 (see FIG. 1) by providing a location-specifying memory corresponding to a filter cache or a loop cache for storing at least a portion of the mapping between the memory address and the location in the data RAM 130 of the data to be accessed determined during the tag RAM look up. This stored mapping can be used upon a subsequent cache access to obviate the need for performing power-hungry tag RAM look up.

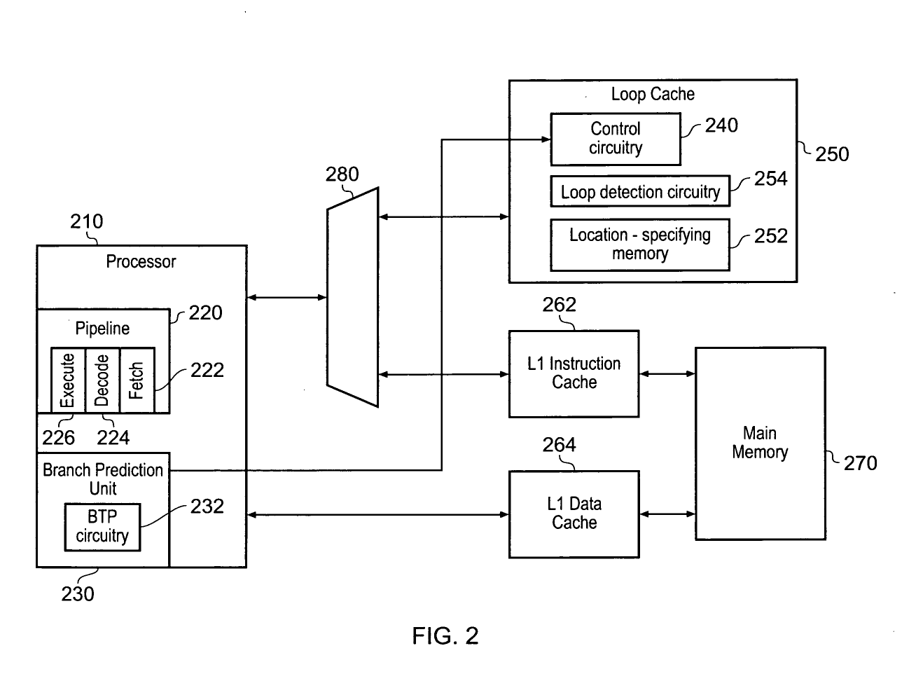

FIG. 2 schematically illustrates a first arrangement of a data processing apparatus corresponding to the present technique. The apparatus comprises: a processor 210 having a pipeline processing circuit 220 and a branch prediction unit 230; loop cache 250, having control circuitry 240, location-specifying memory 252; the branch prediction unit 230 is connected to the loop cache 250; a multiplexer 280 connecting the processor 210 to the loop cache 250 and to an L1 instruction cache 262; an L1 data cache 264; and a main memory 270.

The processor 210 performs data processing operations using the pipeline processing circuit 220, which comprises the fetch stage 222, a decode stage 224 and an execute stage 226. The processor 210 fetches instructions for execution from the main memory 270. Access to data/instructions stored in the main memory 270 is made more efficient by provision of the off-chip L1 instruction cache 262 and L1 data cache 264, which store copies of recently accessed information.

The memory access is hierarchical, i.e., the processor 210 first checks whether or not the information is stored in one of the L1 caches 262, 264 before attempting to retrieve that data from the main memory 270. An additional L0 cache may be provided on-chip (not shown). The loop cache 250 is at the same hierarchical level as the L1 instruction cache 262 and both of these caches are connected to the processor 210 via the multiplexer 280.

The loop cache 250 comprises loop detection circuitry 254 in the cache, which is responsive to branch instructions or memory addresses to detect program loops. The loop cache 250 stores sequences of instructions corresponding to detected program loops to speed up access to those instructions. The L1 data cache 264 is accessed via a different communication path from the loop cache 250 so the presence of the loop cache 250 should not adversely affect the data access time. The loop cache 250 consumes less power per access, is smaller and has fewer cache ways than the L1 instruction cache 262. In this embodiment, the loop detection circuitry 254 dynamically identifies program loops by detecting “small backwards branches (SBB)”. Note that the SBB loop detection scheme is unlikely to capture loops that contain internal branches. In alternative arrangements, the loop detection circuitry 254 identifies loops by statically profiling program code.

The loop cache 250 of FIG. 2 differs from the loop cache of known data processing systems by provision of the location-specifying memory 252. The location-specifying memory 252 is configured to store mapping data (or a portion thereof) relating cache storage locations to memory addresses and derived from previous cache tag lookups in the L1 instruction cache 262. In this arrangement, the mapping data comprises cache way information for the storage location in the L1 instruction cache 262 as well as a start address and an end address of the corresponding loop. Since the location-specifying memory 252 stores L1 cache mapping data there is no need to store the corresponding cache line data. Rather, the instructions associated with the mapping data stored in the location-specifying memory can be rapidly and efficiently retrieved from the L1 instruction cache 262 using the mapping data from the location-specifying memory 252. When a loop is identified by the loop detection circuitry, the loop start and end address are stored, and the mapping data for instructions of the loop is stored in the location-specifying memory 252 of the loop cache 250. Subsequent iterations through the loop fetch the instructions from the L1 instruction cache using the mapping data stored in the location-specifying memory 252, which means that a cache-tag lookup need not be performed.

The branch prediction unit 230 determines whether or not a conditional branch in the instruction flow of a program being executed by the processor 210 is likely to be taken or not. The branch prediction unit 230 allows the processor 210 to fetch and execute program instructions without waiting for a branch to be resolved. This improves the throughput of instructions. Most pipelined processors, like the processor 210 of FIG. 2, perform branch prediction of some form, since they predict the address of the next instruction to fetch before the current instruction has been executed to improve throughput. The branch prediction unit 230 serves to reduce the performance penalty that results from altering the flow of the program instructions.

The branch prediction unit 230 comprises branch target prediction circuitry 232, which is configured to determine the target of a conditional branch instruction or an unconditional jump before it is actually computed by the processor parsing the instruction itself. Effectively, the branch target prediction circuitry 232 predicts the outcome of the conditional branch (or unconditional branch) The branch prediction circuitry 230 is coupled to the loop cache 250 and in particular to the control circuitry 240. However, in alternative arrangements, a different communication path may be provided for supply of the branch prediction information to the loop cache.

The control circuitry 240 supplies branch prediction information from the branch prediction circuitry 230 to the loop cache 250, which uses this information to determine whether or not to load program instructions corresponding to a particular loop. Furthermore, in the example arrangement of FIG. 2, the output of the branch-target prediction circuitry 232 is supplied to the loop cache 250 to the control circuitry 240 and the loop cache 250 uses the branch target prediction to preferentially pre-load the loop cache with program instructions corresponding to the branch destination when there is a strongly predicted branch. In particular, the branch target calculated by the branch target prediction circuitry 232 is compared by the control circuitry 240 with a current instruction address and if there is a match then the instructions are preloaded into the loop cache 250 before the SBB is executed. This reduces the number of times that the loop of program instructions must be fetched from the L1 instruction cache 262 and thus reduces power consumption.

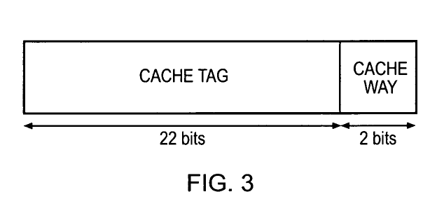

FIG. 3 schematically illustrates the mapping information stored by the location-specifying memory according to the present technique. The mapping comprises a 22-bit cache tag (for a 32-bit memory address, 8 KB, 16B line, 4 way cache) and a 2-bit field for specifying the cache way. The particular example of FIG. 3 corresponds to the cache configuration of FIG. 1, clearly in alternative arrangements the number of bits allocated to storing the each of the cache way may vary as required. The cache tag storage locations in FIG. 3 correspond to cache lines in the cache 262, 264. A loop cache further comprises information specifying the start and end address of the loop of instruction. Alternative loop cache implementations may not store the cache tag and instead rely on the start address and index into a cache way buffer to determine which entry to select.

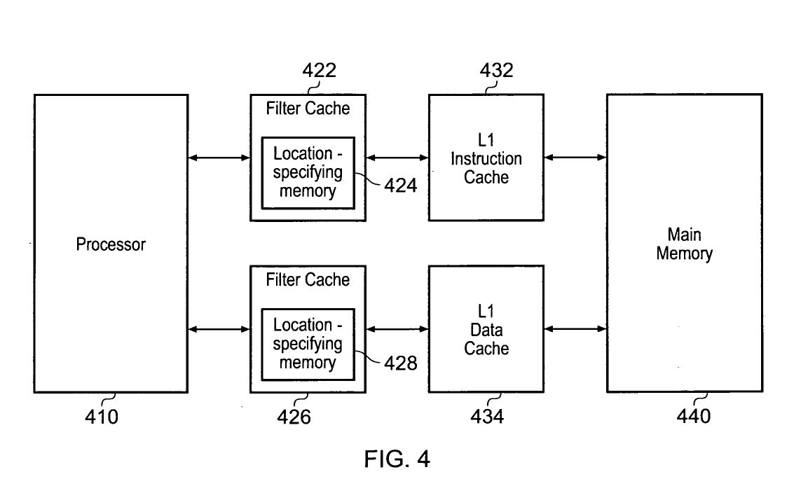

FIG. 4 schematically illustrates a second data processing apparatus according to the present technique, which comprising filter caches instead of the loop cache of FIG. 2. The arrangement of FIG. 4 comprises: a processor 410, a first filter cache 422, a second filter cache 426, an L1 instruction cache 432, an L1 data cache 434 and a main memory 440. The first filter cache 422 and second filter cache 426 have respective location-specifying memories 424, 428. The filter caches 422, 426 are incorporated in the cache memory system in order to reduce the overall cache power consumption by reducing the number of cache-tag lookups in the L1 caches 432, 434. The filter caches 422, 426 differ from the loop cache 250 of FIG. 2 in that they are necessarily accessed prior to their respective L1 caches for each data access operation. By way of contrast, the multiplexer 280 of FIG. 2 provides two alternative paths: (i) a direct path to the L1 instruction cache 262; and (ii) and indirect path via the loop cache 250 to the L1 instruction cache 262. Thus the loop cache can be considered to be an L1 cache whereas the filter caches of FIG. 4 can be considered to be L0 caches in the cache hierarchy.

The filter caches 422, 424 are small by comparison to the respective L1 caches 432, 434 and their architecture means that look-ups in the filter caches 422, 426 consume considerably less power than performing an access to the corresponding L1 cache. However, these characteristics of the filter caches have the consequence that the filter caches 422, 426 have high miss rates. It follows that the reduced power consumption achievable by use of the filter caches is slightly offset by the reduction in processor performance resulting from the high miss rates. Filter caches can reduce cache power consumption by around 58% whilst reducing processor performance by around 21% so that the overall processor power consumption can still be reduced around 29% relative to a system without the filter caches.

In the arrangement according to the present technique, the data storage capacity of the filter caches 422, 426 is efficiently used by storing mapping data that maps a memory address to a data storage location in the corresponding L1 cache 432, 434. This mapping data is used on subsequent accesses to that memory address (for as long as it remains stored in the filter and L1 cache). The mapping data stored by the filter caches 422, 426 of FIG. 4 is similar to the mapping data illustrated in FIG. 3. However, in this case, each filter cache entry corresponds to a single cache line rather than to a loop, so start/end address information is not required. Note that the loop cache 250 of FIG. 2 can be used to reduce the power consumption of the L1 instruction cache 262 but not the L1 data cache 264 whereas the filter cache arrangement of FIG. 4 can be used to reduce the power consumption of both the L1 instruction cache 432 and the L1 data cache 434.

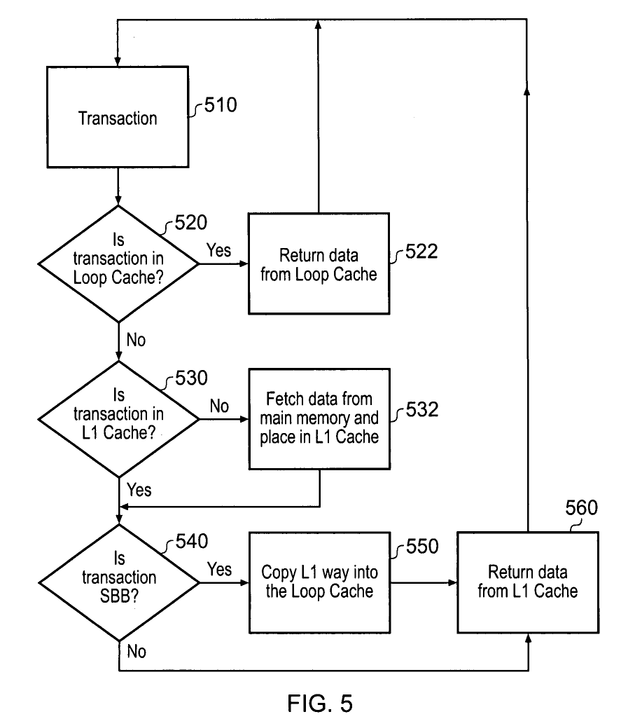

FIG. 5 is a flow chart that schematically illustrates how an instruction access is performed in the data processing apparatus of FIG. 2, which comprises a loop cache. The process beings at stage 510 where the fetch stage of the processor attempts to fetch an instruction corresponding to a given memory address. The process proceeds to stage 520 whereupon the loop cache 250 (see FIG. 2) is accessed to determine whether or not the requested instruction is present therein. If the data is in fact currently stored in the loop cache, it is returned from the loop cache 250 to the processor 210 for decoding and execution by the processing circuitry 220. If, on the other hand, at stage 520 there is a miss in the loop cache 250 then the process proceeds to stage 530 where the L1 instruction cache 262 is accessed to determine whether or not the instruction is present there.

If there is a also miss in the L1 cache at stage 530, then the process proceeds to stage 532 where the processor fetches the data from the main memory 270 and stores it in the L1 cache 262 and thereafter the process proceeds to stage 540. If, on the other hand, it is determined at stage 530 that the instruction is currently stored in the L1 cache then the process also proceeds directly to stage 540. At stage 540 the loop detection circuitry 254 determines whether the instruction corresponding to the transaction at stage 510 is associated with a Small Backwards Branch. If the requested instruction is not identified as corresponding to a Small Backwards Branch then the process proceeds directly to stage 560 where the requested instruction is retrieved from the L1 cache and returned to the data processor. However, if at stage 540 it is determined that the current instruction that does in fact correspond to a Small Backwards Branch then the process proceeds from stage 540 to stage 550 (prior to progressing to stage 560).

At stage 550 the start and end address of the loop and L1 cache mapping information for the instruction (cache way) is stored in the loop cache 250. For simplicity the flow diagram shows all of the L1 cache mapping information being copied into the loop cache at this stage. However it is expected that a number of transactions 510 will be required to copy all the L1 cache mapping information for a loop into the loop cache 250. Accordingly, on a subsequent iteration of the loop, the instructions can be retrieved form the L1 cache based on the mapping data stored in the loop cache. The process of the flow chart of FIG. 5 differs from known arrangements in that at stage 550 only the mapping data (cache way) is written into the loop cache and not the instruction data itself. The performance benefit from storing the mapping data in the loop cache is derived on subsequent iterations on the loop.

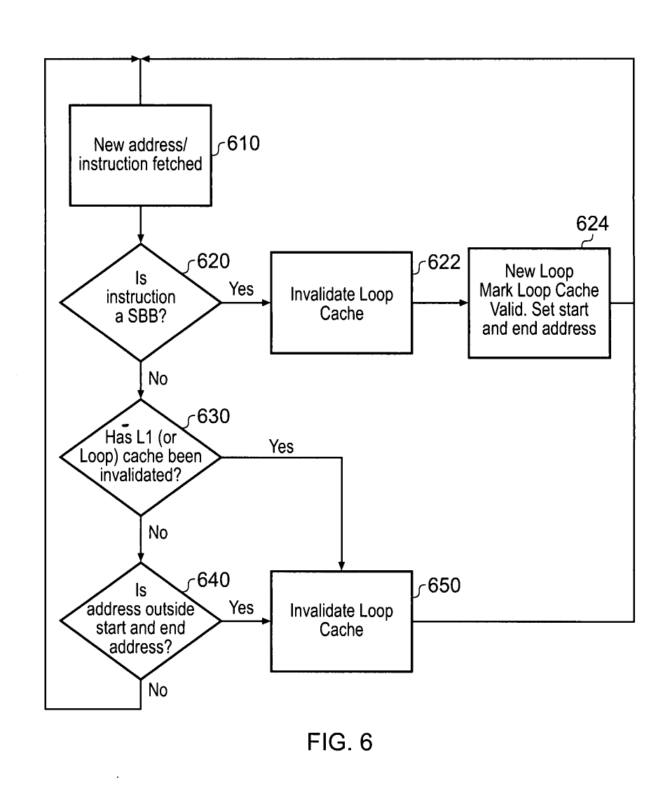

FIG. 6 is a flow chart that schematically illustrates a first scheme for invalidating loop cache entries in the data processing apparatus of FIG. 2. The process begins at stage 610 where the pipelined processing circuitry 220 attempts to fetch a new instruction i.e. to access a given memory address. Next at stage 620 it is determined whether or not the instruction corresponds to a Small Backwards Branch i.e. it is determined whether or not the instruction to be fetched belongs to a loop. If it is determined at stage 620 that the instruction does in fact belong to a loop then the process proceeds to stage 622 whereupon the loop cache 250 is invalidated in preparation for loading it with the new loop data. Clearly, the need to evict existing loop data from the loop cache will be dependent upon the loop cache storage capacity. The loop cache may well be capable of concurrently storing mapping data for a plurality of loops.

The process then proceeds to stage 624 where the mapping data for the newly detected loop are stored in the loop cache 250, the start and end address corresponding to the loop are set and the loop cache is marked as valid. Recall that according to the present technique the instructions per se need not be stored in the loop cache, but instead the start and end addresses corresponding to the instruction loop and the mapping data providing the mapping between the relevant instructions and locations in the L1 instruction cache 262 are stored in the loop cache 250.

Returning to stage 620, if it is decided that the instruction to be fetched does not in fact belong to a loop (i.e. does not correspond to a Small Backwards Branch) then the process proceeds to stage 630 where it is determined whether or not information stored in the L1 instruction cache 262 or indeed the loop cache 250 has been invalidated. If so then the invalidation of the L1 instruction cache or the loop cache is performed at stage 650 and the process then returns to stage 610 where a new address/instruction is fetched. However, if it is instead determined at stage 630 that there has been no invalidation of either the L1 instruction cache or the loop cache then the process proceeds to stage 640. At stage 640 it is determined whether the address of the instruction to be fetched is outside the start and end addresses of the loop of instructions currently stored by the loop cache 250.

If the instruction currently being fetched is outside the start and end addresses of the loop stored in the loop cache then the process proceeds to stage 650 where the loop cache is invalidated. This is because all iterations of the loop are judged to be complete when an instruction outside the loop is encountered. If, on the other hand, the address of the instruction to be fetched is contained between the start and end address of the loop cache (i.e. it is an instruction belonging to the loop) then the process returns to stage 610 where the next instruction is fetched.

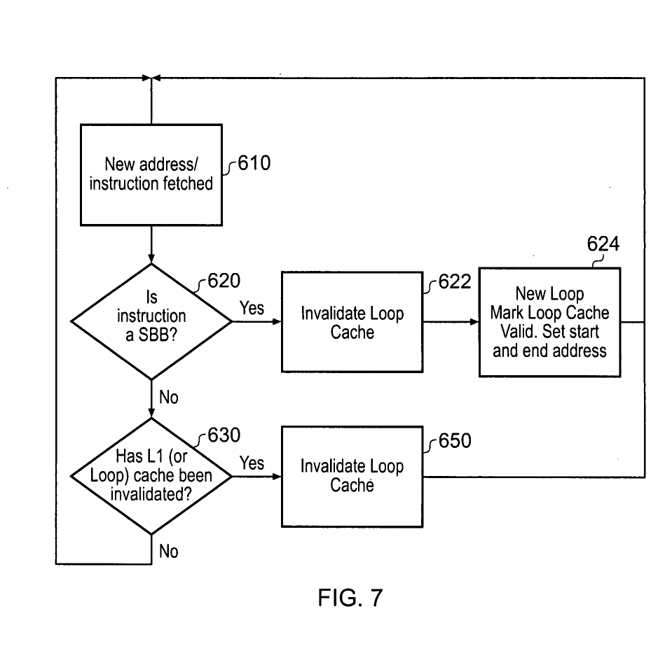

FIG. 7 is a flow chart that schematically illustrates an alternative loop cache invalidation scheme for the data processing apparatus of FIG. 2. The stages in the flow chart of FIG. 7 involve the same processing as the correspondingly numbered stages in the flow chart of FIG. 6. It can be seen by a comparison of the flow chart of FIG. 7 with the flow chart of FIG. 6 that the difference between the two invalidation schemes is that in the flow chart of FIG. 7, the stage 640 (checking if current address is outside start/end addresses of loop) is omitted. Instead following stage 630 if neither the L1 instruction cache nor the loop cache has been invalidated the process simply returns to stage 610 where a new instruction/address is fetched. Thus in the scheme of FIG. 7 if the current instruction to be fetched does not belong to the loop of instructions currently stored in the loop cache, the loop cache will not necessarily be invalidated.

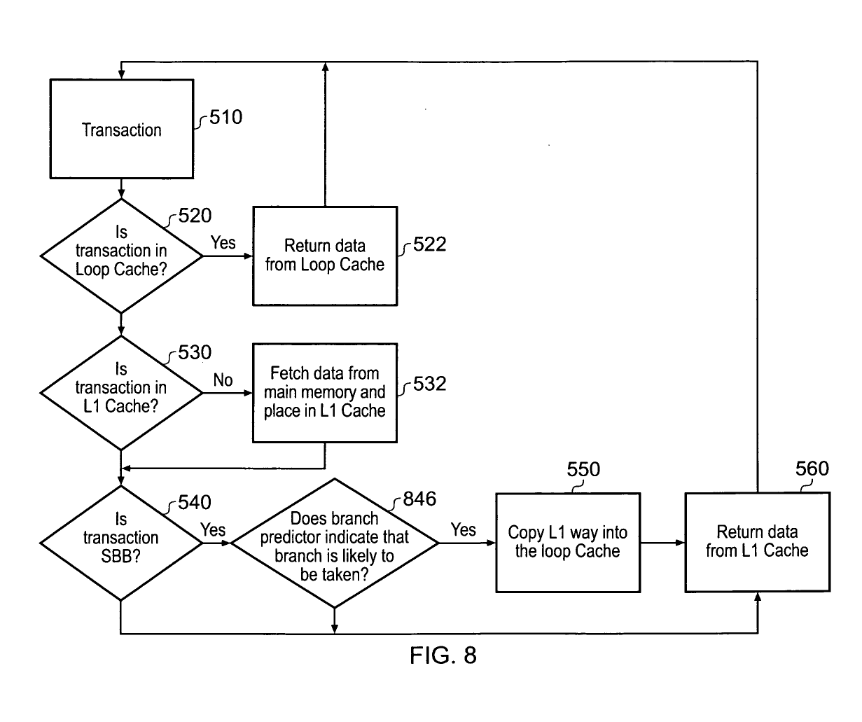

FIG. 8 is a flow chart describing an instruction access in the data processing apparatus of FIG. 2 (having the loop cache) in the case where the branch prediction circuitry 232 is used to determine how the loop cache 250 should be loaded.

The flow chart of FIG. 8 is very similar to the flow chart of FIG. 5 and correspondingly numbered stages involve the same processing as described above with reference to FIG. 5. The main difference between the flow chart of FIG. 8 and the flow chart of FIG. 5 is that in the system of FIG. 8 there is an additional step inserted between stage 540 (determining whether or not the instruction corresponds to a Small Backwards Branch) and the stage 550 (copying of cache mapping information into loop cache). In particular, the new step, stage 846, involves determining whether the branch prediction circuitry 232 indicates that the branch is likely to be taken. If it is determined at stage 848 that a given branch is in fact likely to be taken, then the process proceeds to stage 550, whereupon the cache way information for the loop data is copied from the L1 instruction cache 262 into the loop cache 250. If, on the other hand, it is determined at stage 846 that the identified branch is not likely to be taken, then the mapping information in not in fact copied into the loop cache 250, but instead the requested instruction data is simply returned from the L1 instruction cache 262 without writing anything into the loop cache. This avoids wasting processing resources by writing data into the loop cache if it has a low likelihood of being used.

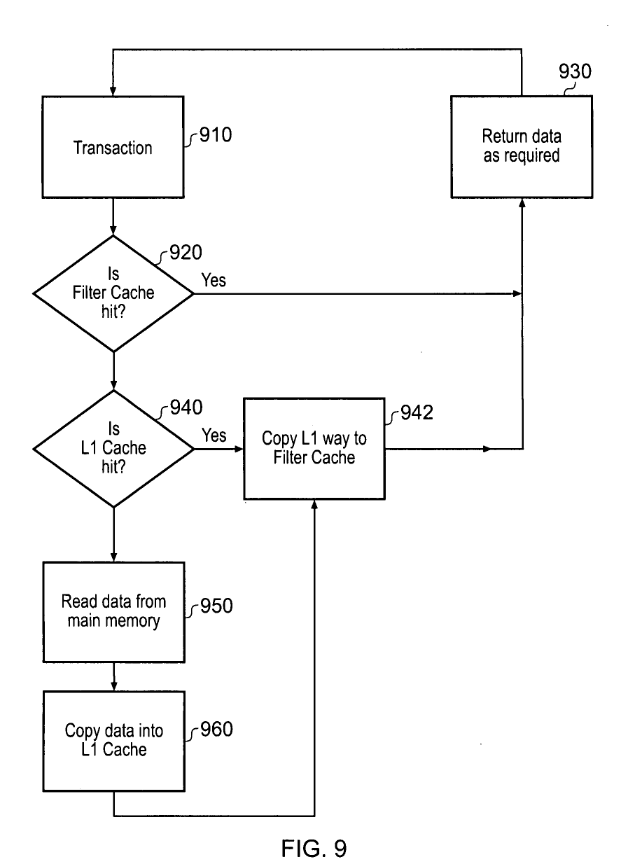

FIG. 9 is a flow chart that schematically illustrates a sequence of processing events that occurs when a memory access is performed in the arrangement of FIG. 4, which comprises a filter cache.

At stage 910 a memory-access transaction is received for processing by the pipelined processing circuitry of the processor 410 (see FIG. 4). The process proceeds to stage 920 where one of the filter caches 422, 426 is accessed to determine whether or not the required data/instruction is stored therein. Clearly, where access to an instruction is requested, filter cache 422 will be checked, but where access to data is requested the filter cache 426 will be checked.

If there is a hit in the appropriate filter cache 422, 426 at stage 920, the process proceeds to stage 930 where the data is returned from the filter cache to the processor 410. If, on the other hand, there is a filter cache miss at stage 920 then the appropriate L1 cache (either the instruction cache 432 or the data cache 434 is accessed). If there is a hit in the L1 cache at stage 940, then the process proceeds to stage 942, whereupon the cache way determined during the L1 cache look-up is copied into the corresponding filter cache 422 or 426. The process then proceeds to stage 930 where the data is returned from the L1 cache.

However, if there is a miss in the L1 cache at stage 940, the process proceeds to stage 950 whereupon the main memory 440 is accessed to retrieve the requested data or instruction. Once the information has been retrieved from the main memory at stage 950, it is copied into the L1 instruction cache 432 or the L1 data cache 434 at stage 960. The process then proceeds to stage 942 where the mapping information that was used at stage 960 to determine where in the L1 cache to store the data that was retrieved from main memory is written into the appropriate filter cache 422 or 426. In particular, the mapping information is written into the location-specifying memory 424 or 428 of the corresponding filter cache. Once the mapping information has been stored in the appropriate filter cache at stage 942, the process proceeds to stage 930 where the required data/instruction is returned to the processor 410.

Note that in the process illustrated by FIG. 9, the mapping information is copied into the filter cache 422 or 426 both in the case of an L1 cache hit (stage 940) and in the case of having retrieved data from the main memory and stored it into the L1 cache at stages 950 and 960. Accordingly, on subsequent attempts to access an instruction/data associated with the given memory address, there will be a filter cache hit at stage 920 and the mapping information stored in the filter cache will be used to retrieve the corresponding instruction or data from the L1 cache without the requirement to perform the power-hungry cache tag look up.

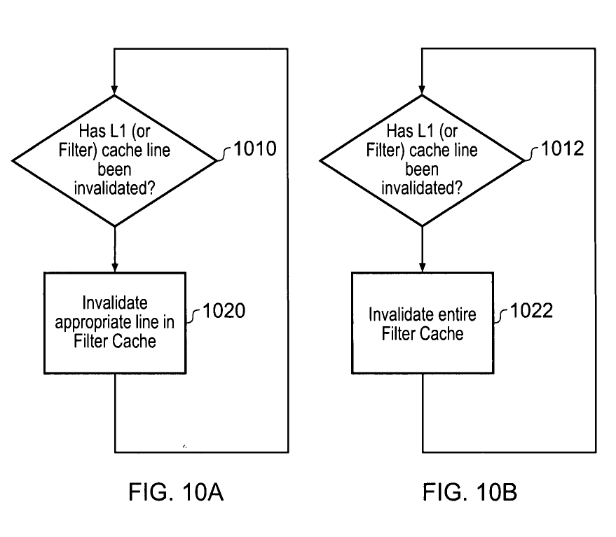

FIG. 10A and FIG. 10B schematically illustrate two alternative invalidation schemes for the filter caches of FIG. 4. In the flow chart of FIG. 10A, a first stage 1010 involves determining whether either an L1 cache line or a filter cache line has been invalidated. If no invalidation of a cache line has occurred then no action will be taken. However, if an L1 cache line is found at stage 1010 to have been invalidated then the appropriate line in the corresponding filter cache 422 or 426 will be invalidated at stage 1020.

In the alternative filter cache invalidation scheme of FIG. 10B, the process begins at stage 1012 where it is determined whether or not an L1 cache line has been invalidated (or indeed a filter cache line). In this case, rather than determining the corresponding line in the filter cache 422 or 426, the entire filter cache is flushed i.e. invalidated. The scheme of FIG. 10B is simpler to implement of that of FIG. 10A, but is likely to involve flushing of some valid filter cache data/instructions.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. Apparatus for processing data comprising:
a cache memory having a storage array comprising a plurality of cache lines and a cache tag array providing an index of memory locations associated with data elements currently stored in said cache memory;
a cache controller coupled to said cache memory and responsive to a cache access to perform a cache lookup with reference to said cache tag array to establish whether information corresponding to a given memory address is currently stored in said cache memory and, if so, to identify a mapping between said given memory address and a corresponding cache storage location;
a location-specifying memory operable to store at least a portion of said mapping determined during said cache lookup;
wherein upon a subsequent cache access to said given memory address said cache controller is arranged to access said location-specifying memory and to use said stored mapping to access said information corresponding to said given memory address in said storage array of said cache memory instead of performing said cache lookup.

2. Apparatus as claimed in claim 1, comprising a further cache memory and wherein said further cache memory comprises said location-specifying memory.

3. Apparatus as claimed in claim 2, wherein said further cache memory stores said mapping data without storing corresponding cache line data and said data processing apparatus is configured to use said mapping data from said further cache memory to retrieve said information from said cache memory.

4. Apparatus as claimed in claim 2, wherein said cache memory and said further cache memory form a cache hierarchy having a plurality of hierarchical levels and wherein said further cache memory belongs to a lower hierarchical level than said cache memory.

5. Apparatus as claimed in claim 2, wherein said further cache memory is a buffer memory.

6. Apparatus as claimed in claim 4, wherein said further cache memory is a filter cache and said cache memory is a level-one cache.

7. Apparatus as claimed in claim 6, wherein said cache memory is at least one of an instruction cache and a data cache.

8. Apparatus as claimed in claim 2, wherein said data processing apparatus comprises loop detection circuitry and wherein said further cache memory is a loop cache.

9. Apparatus as claimed in claim 1, wherein said cache memory is a set-associative cache memory having a plurality of cache ways.

10. Apparatus as claimed in claim 9, wherein said mapping comprises at least one of a cache tag and cache way information corresponding to said given memory address.

11. Apparatus as claimed in claim 1, comprising invalidation circuitry coupled to said cache memory and said location-specifying memory, wherein said invalidation circuitry is arranged to selectively invalidate mapping data stored in said location-specifying memory when a corresponding line of said cache memory is invalidated.

12. Apparatus as claimed in claim 11, wherein said invalidation circuitry is configured to flush all of said mapping information from said location-specifying memory when at least one line of said cache memory is invalidated.

13. Apparatus as claimed in claim 1, wherein said data processing apparatus comprises a main memory and wherein said mapping information is stored in said location-specifying memory in response to said information being retrieved from said main memory and stored in said cache.

14. Apparatus for processing data comprising:
a pipelined processing circuit for executing program instructions including conditional branch instructions;
a cache memory;
loop detection circuitry responsive to memory addresses of instructions to detect program loops;
a buffer memory coupled to said cache memory and said loop detection circuitry, said buffer memory being arranged to store instruction data for at least a portion of one of said detected program loops;
branch prediction circuitry configured to generate branch prediction information providing a prediction of whether a given one of said conditional branch instructions will result in a change in program execution flow;
control circuitry coupled to said buffer memory and said branch prediction circuitry, said control circuitry arranged to control said buffer memory to store program instructions in dependence upon said branch prediction information.

15. Apparatus as claimed in claim 14, wherein said buffer memory is a buffer memory coupled to said loop detection circuitry, said buffer memory being arranged to store at least a portion of said program loop.

16. Apparatus as claimed in claim 14, comprising branch target prediction circuitry for predicting a branch-target instruction address corresponding to said given conditional branch instruction.

17. Apparatus as claimed in claim 14, wherein said branch prediction information comprises said branch-target instruction address.

18. Apparatus as claimed in claim 14, wherein said loop detection circuitry performs said detection of program loops by statically profiling a sequence of program instructions.

19. Apparatus as claimed in claim 14, wherein said loop detection circuitry performs said detection of program loops by dynamically identifying small backwards branches during execution of program instructions.

20. Apparatus as claimed in claim 17, wherein said branch prediction circuitry is configured to provide a likelihood value giving a likelihood that a predicted branch will be taken and wherein said control circuitry is responsive to said likelihood value to control storage of program instructions corresponding to said predicted branch.

21. Apparatus as claimed in claim 14, wherein said buffer memory is configured to store mapping information providing a mapping between a memory address and a storage location of one or more program instructions corresponding to said memory address in said cache memory.

22. Apparatus as claimed in claim 21, wherein said buffer memory is configured to store said mapping information without storing the corresponding program instructions and wherein said data processing apparatus is configured to use said mapping information to retrieve said program instructions from said cache memory.

23. Apparatus for processing data comprising:
means for cacheing having a means for storing data comprising a plurality of cache lines and a means for storing cache tags providing an index of memory locations associated with data elements currently stored in said means for cacheing;
means for controlling coupled to said means for cacheing and responsive to a cache access to perform a cache lookup with reference to said means for storing cache tags to establish whether information corresponding to a given memory address is currently stored in said means for cacheing and, if so, to identify a mapping between said given memory address and a corresponding cache storage location;
means for storing location information operable to store at least a portion of said mapping determined during said cache lookup;
wherein upon a subsequent cache access to said given memory address said means for controlling is arranged to access said means for storing location information and to use said stored mapping to access said information corresponding to said given memory address in said means for storing data of said means for cacheing instead of performing said cache lookup.

24. Apparatus for processing data comprising:
means for processing for executing program instructions including conditional branch instructions;
means for cacheing information;
means for loop detection responsive to memory addresses of instructions to detect program loops;
means for buffering coupled to said means for cacheing information and said means for loop detection, said means for buffering being arranged to store instruction data for at least a portion of one of said detected program loops;
means for branch prediction configured to generate branch prediction information providing a prediction of whether a given one of said conditional branch instructions will result in a change in program execution flow;
means for controlling coupled to said means for buffering and said means for branch prediction, said means for controlling arranged to control said means for buffering to store program instructions in dependence upon said branch prediction information.
